(19) United States
(12) Patent Application Publication
(10) Pub. No.: US 2003/0209887 A1
(43) Pub. Date: Nov. 13, 2003

(54) Anticompression clip for airbag deployment systems

(75) Inventor: Paul E. Koenig, Whitmore Lake, MI (US)

Correspondence Address: FOLEY & LARDNER, 777 EAST WISCONSIN AVENUE, SUITE 3800, MILWAUKEE, WI, 53202-5308, US

(73) Assignee: Johnson Controls Technology Company

(21) Appl. No.: 10/142,291

(22) Filed: May 9, 2002

(51) Int. Cl. B60R 21/16

(52) U.S. Cl. 280/728.2

(57) ABSTRACT

An anticompression clip is provided for a resilient foam layer located adjacent an airbag deployment component to prevent the layer from compressing at the time of deployment so as to ensure maximum deployment forces in the desired direction. A two-piece I-beam clip is used in the preferred embodiment, the clip including plates on either side of the layer and engagement portions which prevent the plates from moving toward one another when the engagement portions are fully engaged.

Cross-reference to related applications, if any: None.

### BACKGROUND OF THE INVENTION

1. Field of the Invention

The present invention relates generally to the field of airbag deployment systems and more particularly to a system for ensuring that maximum deployment forces are exerted in the desired direction. In its most preferred form, the present invention relates to an anticompression clip which is provided for a foam layer adjoining an airbag component.

2. Description of the Relevant Art

Airbag deployment systems have been used in vehicles, such as cars, vans, SUVs, light trucks, and the like, for many years. In most systems, a sensor detects an event calling for deployment of an airbag, which deployment is initiated by a rapid blast of a gas coming from an igniter coupled to the sensor. The airbag may be deployed from a canister through an instrument panel, a steering wheel, along the side rails of a vehicle, from an overhead location, a vehicle seat, or the like, and typically, the bag blasts through a weakened area. The airbag itself follows the path of least resistance after an opening has been made in a vehicle trim element.

One problem encountered in the design of airbag systems includes mounting of the canister so that forces exerted therewithin will be directed into the bag and out through the bag opening. Any tendency of the airbag canister or other holder to move in a direction opposite to that desired will result in a diminution of the effective deployment of the bag. Several systems are known which include a foam layer behind the airbag canister, a situation which may be more prevalent when dealing with seat mounted airbags and those mounted in the headliner or side rail areas of the vehicle. To avoid problems with the required force of airbag deployment, it has been proposed to use a dense foam block in the area immediately behind the canister or to put a foam cradle behind the airbag module, thereby requiring an inventory of separate parts and the proper location thereof during assembly. It would be advantageous to provide an airbag deployment system in which foam elements lie adjacent the deployment canister and in which undesirable compression of the foam is prevented. Such a system would facilitate assembly and reduce cost of the overall system.

Several fastener systems are disclosed in prior art related to airbag installation. For example, U.S. Pat. No. 6,142,509 was issued to White et al. on Nov. 7, 2000 for a “Fastener Structure for a Vehicle Occupant Protection Apparatus Including an Inflatable Curtain”. In this patent, the fastener prevents a housing wall from being deformed toward the vehicle occupants.

Another fastener system is shown in U.S. Pat. No. 6,082,761 issued Jul. 4, 2000 to Kato et al., for a “Side Airbag Device”. In this device, the fasteners are used to attach the airbag system to a vehicle structure, but no foam layers are interposed between the components held by the fastener.

Another fastener is shown in “Side Air Bag Module Attachment”, U.S. Pat. No. 5,947,630, issued Sep. 7, 1999 to Dillon. In this device, the fastener includes a rivet portion and a shaft extending therefrom along with a spring cup. Again, the fastener is used to attach airbag components directly to a vehicle structure.

In “Air Bag Housing Assembly”, U.S. Pat. No. 6,145,870, issued Nov. 14, 2000 to Devane et al., an airbag housing assembly includes a flexible strap to hold an airbag door to a vehicle structural member. A quick connect fastener is used for the attachment of the strap element.

Other airbag fastening systems are shown in Fleckenstein et al., U.S. Pat. No. 5,810,535, issued Sep. 22, 1998; Iwanaga, U.S. Pat. No. 6,234,515, issued May 22, 2001; Ford, U.S. Pat. No. 6,149,183, issued Nov. 21, 2000; Ricks, U.S. Pat. No. 5,947,509, issued Sep. 7, 1999; Bentley, U.S. Pat. No. 5,765,862, issued Jun. 16, 1998; Hagen et al., U.S. Pat. No. 5,651,562, issued Jul. 29, 1997; Szigethy, U.S. Pat. No. 5,350,190, issued Sep. 27, 1994; Landis, U.S. Pat. No. 5,333,897, issued Aug. 2, 1994; and Aird, U.S. Pat. No. 5,152,549, issued Oct. 6, 1992.

While the above-referenced art is related to airbag mounting, none of it concerns the particular problem addressed by the present invention, namely preventing foam from compressing during airbag deployment, thereby reducing overall airbag effectiveness.

### FEATURES AND SUMMARY OF THE INVENTION

A primary feature of the present invention is to provide an anticompression clip for foam components lying adjacent airbag deployment systems.

Another feature of the present invention is to provide a clip which may be used with existing foam components and which will prevent compression thereof at the time of airbag deployment.

A still further feature of the present invention is to provide an airbag deployment anticompression clip which may be advantageously used in a wide variety of airbag systems.

A different feature of the present invention is to provide an anticompression clip which is easy to install and which is effective in preventing compression of foam.

Yet a further feature of the present invention is to provide an anticompression clip which relies on an “I-beam” principle to prevent foam compression.

How these and other features of the invention are accomplished individually, collectively, or in various subcombinations, will be described in the following detailed description of the preferred embodiment, taken in conjunction with the FIGURES. Generally, however, they are provided by using an anticompression clip which includes two elements which may be secured together through a foam layer, each element having planar or contoured portions, which lie on opposite faces of the foam. In a most preferred embodiment, the clip includes two elongated plates, each of which has an extension which ends in an engagement element. The extensions are inserted into each other to lock the plates a specific distance apart from one another. The assembly resists compression of the foam located between the plates and thereby ensures deployment of the airbag to the fullest extent possible. The resulting I-beam configuration provides great strength in resisting the explosive forces generated by the igniter forcing gas into the airbag. Other ways in which the features of the invention are accomplished will become apparent to those skilled in the art after they have read this present specification, and such other ways are deemed to fall within the scope of the present invention if they fall within the scope of the claims which follow.

### BRIEF DESCRIPTION OF THE DRAWINGS

FIG. 1 is a top plan view of a foam block for use in a vehicle and illustrating a slot and a recess on one side, another recess being formed on the side not illustrated;

FIG. 2 is a perspective view of two arrow clip components arranged in a side-by-side configuration for purposes of illustration;

FIG. 3 is a perspective view of the arrow clip components of FIG. 2 shown in an engaged configuration to form an I-beam shape.

FIG. 4 is a perspective view of the foam block of FIG. 1 with the anticompression clip in place.

FIG. 5 is a schematic illustration, not to scale, showing the clip components and the foam block;

FIG. 6 is a schematic view similar to FIG. 5, but illustrating a different clip engagement technique; and

FIG. 7 is a schematic illustration of another feature of the present invention, i.e., the formation of one of the clip elements to accommodate an angle in the foam block.

In various FIGURES, like reference numerals are used to indicate like components.

### DETAILED DESCRIPTION OF THE PREFERRED EMBODIMENT AND AN ALTERNATE EMBODIMENTS

Before proceeding to the detailed description of the preferred and alternate embodiments of the present invention, several general comments can be made about the applicability and the scope of the present invention.

First, the foam block shown in certain FIGURES is for purposes of illustrating the present invention, and the principles thereof may be adapted to a wide variety of foam blocks having different thickness, length, and widths dimensions. The recess surrounding the slot is not essential, and the length of the cut-out portion can vary widely depending on the particular part. Moreover, one or both sides of the block may be angled or contoured.

Second, the FIGURES show the plates of the individual clip elements received in recesses on opposite faces of the foam block. Such recesses may be eliminated, and in such a case, a slight compression of the foam would take place between the plates as the clip components are engaged.

Third, the preferred clip coupling techniques are shown in the FIGURES, but as noted above, a wide variety of other quick connect couplings could be employed. The fastening need not be reversible, but may be if desired. While an arrow shape is shown for the male coupling component in the illustrations, the shape of the male and female components can be modified. Examples include using a more blunt arrow or bulb-shaped element, a multi-sided shaped element or the like. The receiver would also be modified to receive such a component.

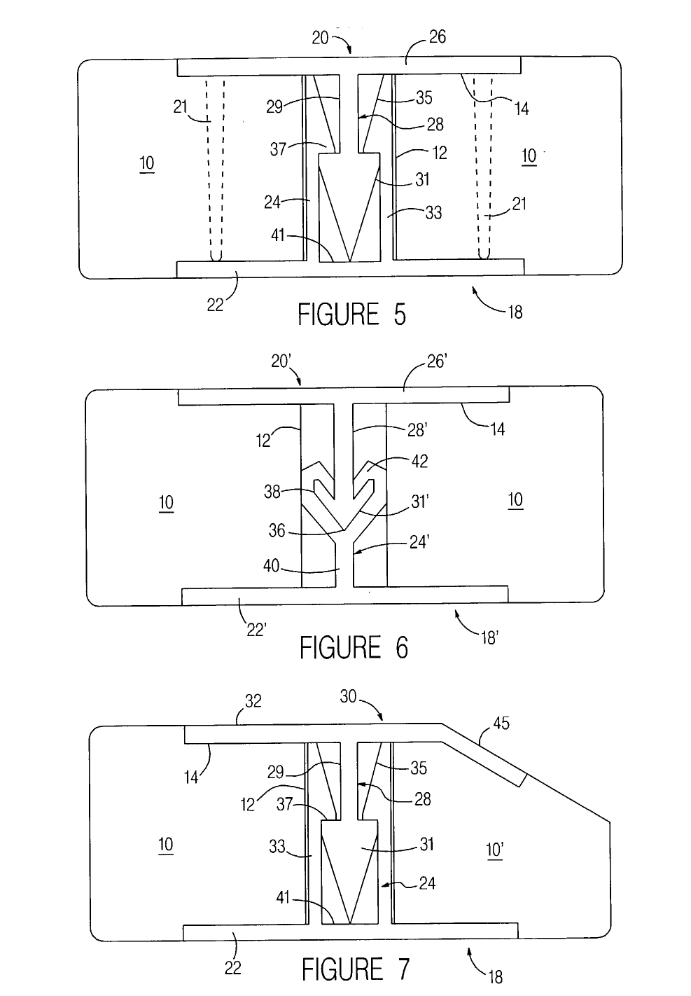

Fourth, and as shown in dashed lines in FIG. 5, anti-rotational ribs may extend from one plate to the surface of the other. Such ribs would prevent rotation or wobbling of the plates during airbag deployment.

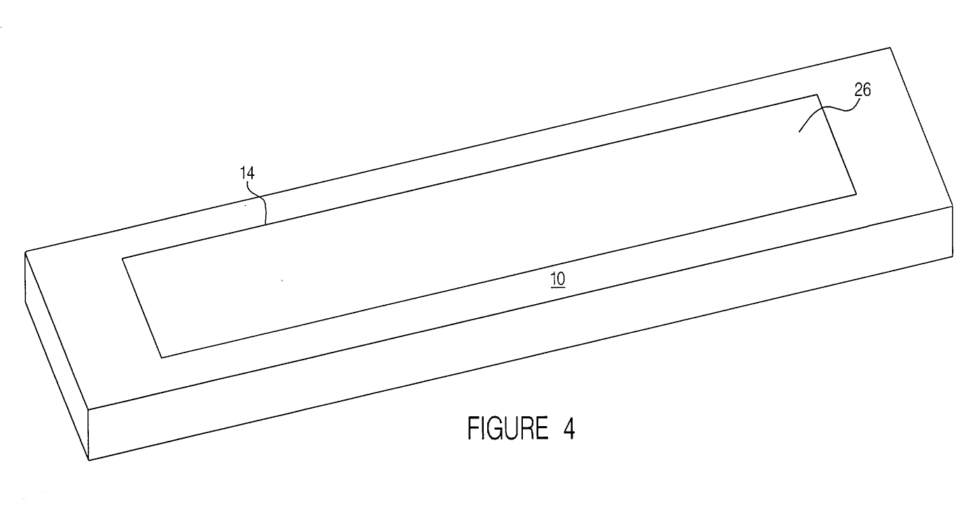

Another preferred feature of the present invention is the use of an I-beam structure, as best illustrated in FIG. 3. Such structure provides a maximum amount of strength for the overall system. However, other arrangements for coupling the plates may be used, such as a plurality of ribs extending between the plates or, in a further embodiment of the invention, the assembled I-beam can be extruded or otherwise formed and placed into the foam block by manipulating one planar portion thereof through the cut-out opening. Obviously, such a procedure would require greater time than merely pressing the two halves of the illustrated compression clip together.

Urethane foam is the most frequently used foam material in the vehicle art, but the invention may be used with any type of compressible material, including materials other than foams, such as blocks of corrugated board, multiple layers of fibrous materials, natural or synthetic rubbers, polymers, etc.

While in many cases, the plates of the anticompression clip will have an identical profile, FIG. 7 illustrates a situation where the foam block has an angled (it could be contoured) portion. This is accounted for in the present invention by making either half of the clip to conform to the angle, and different profiles of the recesses formed in the foam can be provided before the clip is put in place.

With regard to the materials of the clip, plastics are preferred, especially polypropylenes, polyethylenes, and the like, but after one skilled in the art has read the specification and understands its possibilities, those skilled in the art could select a variety of other materials. The resins can be filled or not filled as determined by one having an ordinary level of skill in the art having the benefit of the present specification.

Finally, the invention has been described, and will hereinafter be described, as having preferred utility in connection with airbag deployment systems. However, it should be understood at the outset that the invention may be used in any other application where a foam layer exists, and it is desired to prevent compression thereof during assembly or use of the foam component in the particular end-use application.

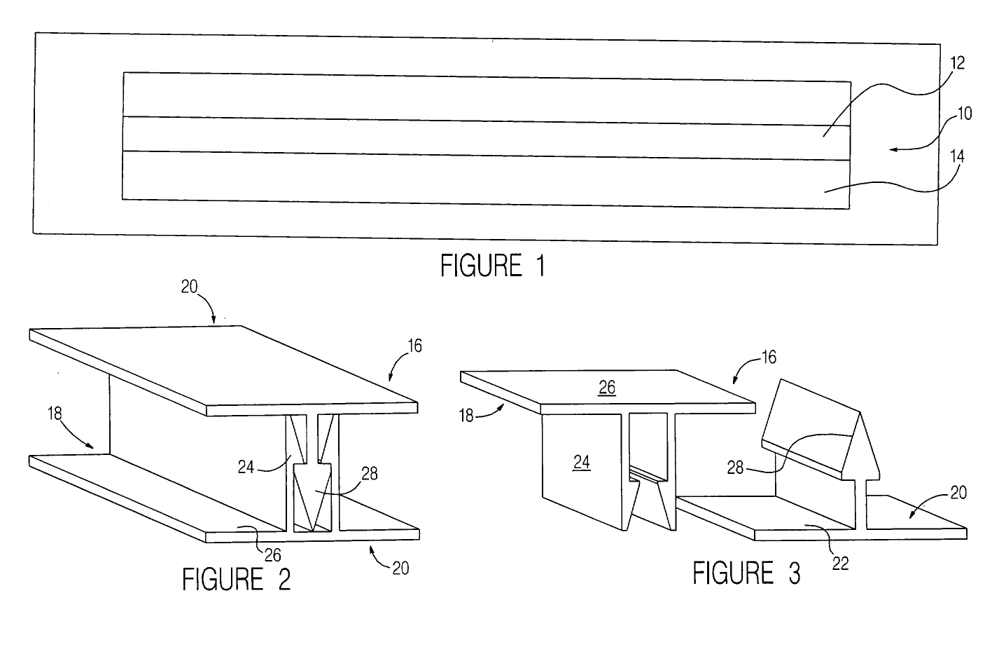

Proceeding now to the description of the preferred and alternate embodiments of the invention, FIG. 1 illustrates a block of foam 10 prepared for use in the present invention. A slot 12 extends across foam block 10 and entirely through the depth of the foam. A recess is formed on both sides of slot 12, the recess most desirably having a depth equivalent to that of the plates of the anticompression clip to be described in subsequent FIGURES. While not shown in this FIGURE, a similar recess is preferably formed on the opposite side of foam block 10. The slot can be made in a variety of ways, including placing a blade in the tool used to form foam block 10 or cutting a complete block of form as illustrated. The foam block 10 would be positioned in its most preferred use at the rear of the canister used to house airbag components.

FIGS. 2 and 3 illustrate a preferred form of an anticompression clip 16. Anticompression clip 16 includes a first, female component 18 and a second, male component 20. Each of components 18 and 20 are elongate and have a length substantially equal to that of slot 12.

Female component 18 includes a generally flat plate 22 and an engagement portion 24 extending from a side thereof. Similarly, component 20 includes a plate 26 and an engagement portion 28 extending therealong. The preferred shapes of engagement portions 24 and 28 are shown best in FIGS. 5-7.

FIG. 3 shows the two components (18 and 20) of the anticompression clip 16 joined together to form an I-beam structure. It will be appreciated from the description to this point that plates 22 and 26 are held at a specified distance from one another when the engagement components 24 and 28 are joined.

FIG. 4 is a view similar to that of FIG. 1 showing foam block 10 and the plate 26 of anticompression clip 16. It can be noted in this FIGURE that the plate 26 fits within the recess 14 so that the overall exterior surface of foam block 10 is flat. On the other side of foam block 10, plate 22 of clip component 18 would be visible in a view from that side.

Referring next to FIGS. 5-7, several illustrative schematic cross-sections are shown. In connection with FIG. 5, it will be noted that the male engagement portion 28 includes a rib 29 and a triangularly shaped tip 31 extending from the end of rib 29 remote from plate 26. The female engagement portion 24 of clip portion 18 includes a pair of parallel walls 33, a converging entrance 35, and a pair of shoulders 37 located approximately at the midpoint of the walls 33. It will be easily noted from this FIGURE that the anticompression clip 16 is fastened by urging the male engagement portion 28 through entrance 35 until the base of triangular portion 31 clears the shoulders 37, which will cause the walls 33 of female engagement component 24 to snap toward one another. The male component 20 can no longer be removed, and since the tip of triangular portion 31 rests against the inside surface 41 of the plate 22, the two plates 22 and 26 cannot move toward one another either. Also shown in phantom in FIG. 5 are a pair of anti-rotational ribs 21 extending from plate 26 to the inner surface of plate 22. The use of such ribs is optional.

Another example is provided in FIG. 6, where certain components are shown with a “′” notation to show differences. The foam block 10 again includes male and female engagement portions 18′ and 20′, each of which includes a plate 22′ and 26′, respectively. In this instance, the male engagement portion includes a rib 28′ having an arrow shaped edge 31′ with a tip 36 and a pair of depending flanges 38. The female clip component 18′ includes a generally Y-shaped receiver including a base rib 40 and a receptacle area 42. The receptacle area 42 is shaped so that when the arrow portion 31′ of male clip 20′ is urged against the receiver portion 42, the tip of the arrow 36 fully engages the female clip component 24′, and the receiving components 42 snap around and hold flanges 38 in a fixed state so that they may not move in either direction. Plate 22′ or 26′ cannot move toward or away from the other, thereby providing the anticompression feature desirable herein.

Finally, a modification of a foam block 10′ is shown in FIG. 7. Many similarities can be noted with FIG. 5, except that the plate 26 of FIG. 5 is replaced by a differently shaped plate 30 including a first portion 32 aligned parallel to plate 18 and a second angled or contoured portion 45 (which could be smoothly curved, contoured, etc.). The engagement components 24 and 28 are identical to those shown in FIG. 5. This FIGURE is included to illustrate the fact that the foam block need not have parallel faces to benefit from the anticompression clip features of the present invention.

While the present invention has been described in connection with a preferred and two alternate embodiments, the reader is again referred to the beginning sections of this specification for descriptions of other ways in which the features of the invention may be accomplished, and the invention is not to be limited with regard to materials, dimensions, and the like. Accordingly, the invention is to be limited solely by the scope of the claims which follow.

What is claimed is:

1. An anticompression clip system for preventing a resilient layer from compressing under a force comprising:
a resilient layer having two sides;
a first clip element on one side of the layer and having an exterior portion and an engagement portion;
a second clip element on the other side of the layer and having an exterior portion and an engagement portion;
the engagement portions of the first and second clip elements adapted to engage one another and when so engaged to prevent the movement of the exterior portions toward one another when the force is applied thereto.

2. The anticompression clip system of claim 1, wherein the resilient layer is a foam layer.

3. The anticompression clip system of claim 1, wherein the resilient layer includes a slot therethrough arranged to receive the engagement portions of the first and second clip elements.

4. The anticompression clip system of claim 1, wherein a recess is provided on each side of the resilient layer arranged to receive the exterior portions of the first and second clip elements.

5. The anticompression clip system of claim 4, wherein the resilient layer includes a slot therethrough arranged to receive the engagement portions of the first and second elements.

6. The anticompression clip system of claim 1, wherein the exterior portions of the first and second clip elements are elongated, rectangular, generally planar plates.

7. The anticompression clip system of claim 6, wherein an elongated rectangular recess is provided on each side of the resilient layer arranged to receive the plates of the first and second clip elements.

8. The anticompression clip system of claim 6, wherein the engagement portions of the first and second clip elements form the center rib of an I-beam clip system when engaged, the center rib being generally perpendicular to the plates of their respective clip element.

9. The anticompression clip system of claim 8, wherein the engagement portion of the first clip element is non-removably received within the engagement portion of the second clip element.

10. The anticompression clip system of claim 9, wherein the engagement portion of the first clip element includes a rib attached perpendicularly to the plate of the first clip element and having a triangularly shaped tip, and further wherein the engagement portion of the second clip element includes a pair of walls having shoulders thereon arranged to capture the tip of the engagement portion of the first clip element when the engagement portions are fully engaged.

11. The anticompression clip system of claim 10, wherein the engagement portions of each of the first and second clip elements engage the plate of the other of the first and second clip elements when the engagement portions are fully engaged, whereby the clip is an antiexpansion as well as an anticompression clip.

12. The anticompression clip system of claim 9, wherein the engagement portion of the first clip element includes a tip and the engagement portion of the second clip element includes a receptacle, and further wherein the tip is captured by the receptacle when the engagement portions are fully engaged.

13. The anticompression clip of claim 6, wherein at least one of the plates includes an angled or contoured portion.

14. The anticompression clip of claim 1 further including at least one anti-rotational rib.

15. An anticompression clip system for being placed adjacent an airbag component, the clip system including a resilient layer located adjacent the component to prevent the resilient layer from being compressed at the time a force is exerted thereagainst during airbag deployment, the system further including an anticompression clip to substantially prevent such compression, the clip comprising:
a first clip element on one side of the layer and having an exterior portion and an engagement portion;
a second clip element on the other side of the layer and having an exterior portion and an engagement portion;
the engagement portions of the first and second clip elements adapted to engage one another and when so engaged to prevent the movement of the exterior portions toward one another when the force is applied thereto.

16. An anticompression clip system of claim 15, wherein the resilient layer is a foam layer.

17. The anticompression clip system of claim 15, wherein the resilient layer includes a slot therethrough arranged to receive the engagement portions of the first and second clip elements.

18. The anticompression clip system of claim 15, wherein a recess is provided on each side of the resilient layer arranged to receive the exterior portions of the first and second clip elements therein.

19. The anticompression clip system of claim 15, wherein the exterior portions of the first and second clip elements are elongated, rectangular, generally planar plates.

20. The anticompression clip system of claim 17, wherein the engagement portions of the first and second clip elements form the center rib of an I-beam clip system when engaged, the center rib being generally perpendicular to the plates of their respective clip element.

21. The anticompression clip system of claim 18, wherein the engagement portion of the first clip element is non-removably received within the engagement portion of the second clip element.

22. The anticompression clip system of claim 19, wherein the engagement portion of the first clip element includes a rib attached perpendicularly to the plate of the first clip element and having a triangularly shaped tip, and further wherein the engagement portion of the second clip element includes a pair of walls having shoulders thereon arranged to capture the tip of the engagement portion of the first clip element when the engagement portions are fully engaged.

23. The anticompression clip system of claim 22, wherein the engagement portions of each of the first and second clip elements engage the plate of the other of the first and second clip elements when the engagement portions are fully engaged, whereby the clip is an antiexpansion as well as an anticompression clip.

24. The anticompression clip of claim 15, wherein at least one of the plates includes an angled or contoured portion.

25. The anticompression clip of claim 15 further including at least one anti-rotational rib.
